(19) United States
(12) Patent Application Publication
(10) Pub. No.: US 2021/0334818 A1
(43) Pub. Date: Oct. 28, 2021

(54) ASSISTANCE AND RECOVERY WORKSTATION PLATFORM WITH BILATERAL MULTI-CHANNEL COGNITIVE RESOURCE INTEGRATION

(71) Applicant: BANK OF AMERICA CORPORATION, Charlotte, NC (US)

(72) Inventors: Jeffrey Y. Lau, Charlotte, NC (US); Christine Marie Donato, Newark, DE (US); Russell Alan Howard, Greenville, SC (US); David R. Meyers, JR., West Grove, PA (US); Peter Joseph Sheeran, Charlotte, NC (US)

(73) Assignee: BANK OF AMERICA CORPORATION, Charlotte, NC (US)

(21) Appl. No.: 17/240,112

(22) Filed: Apr. 26, 2021

Related U.S. Application Data
(60) Provisional application No. 63/016,354, filed on Apr. 28, 2020.

(51) Int. Cl. G06Q 30/00; G10L 15/22; G10L 15/08; G06F 3/16; G06F 3/14

(52) U.S. Cl. CPC G06Q 30/016; G10L 15/22; G06N 20/00; G06F 3/167; G06F 3/1454; G10L 15/08

(57) ABSTRACT

Embodiments of the invention are directed to a system, method, or computer program product for providing a pre-arrears learning system with multi-channel cognitive resource application integration on front and back end applications. The system comprises a hub or workstation for representatives while also allowing for multi-channel cognitive resource application integration as a communication liaison with the user product identification. The system may identify key words during the interaction and provide those points to an representative via a storyboard. Furthermore, the system provides a strategy decision engine for product matching for the user, which allows the representative to mirror graphical user interfaces with the user device for product application.

### CROSS-REFERENCE TO RELATED APPLICATIONS

This application is a U.S. Non-provisional application claiming priority to U.S. Provisional Patent Application No. 63/016,354, filed Apr. 28, 2020 titled Recovery Workstation Platform with Graphical User Interface, the contents of which are hereby incorporated by reference in its entirety.

### BACKGROUND

Customers service is a priority for merchants and other entities. When customers contact a user service representative, the customer service representative should be able to answer the user's questions or concerns. With advancements in technology, a need exists for cross entity learning system for integration of front and back line pre-recovery product and service providing.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatuses (e.g., a system, computer program product and/or other devices) and methods for providing a collection recover learning platform with virtual assistant integration for front and bank end applications.

The invention provides a pre-collections recovery learning system that integrates a virtual assistant on both front and back end (for both the user and the representative). The system comprises a hub or workstation for representatives while also allowing for virtual assistant integration as a communication liaison with the user for collections and recovery. The system may initiate a communication with a user via chat, text, telephone, or the like. The user may interact initially with the virtual assistant. The system may identify key words during the interaction and provide those points to a representative via a storyboard. As such, the system may present the representative with the user platform and the key points based on the initial communication with the virtual assistant. From there, the representative may seamlessly transfer communication from the virtual assistant to the representative. The system provides several other features via the workstation that may be presented on an representative's screen, such as recommended products for the user based on the user's situation and a mirror option that allows the representative to display his/her screen to the user to illustrate how the products may work. The user may be able to sign up and initiate that product at that time via the mirroring option. This also includes the representative being able to view the user filling out applications for the products and allow the representative to help walk the user through the product. Additional add on elements includes a determination of typing shortcuts to identify the user's current disposition based on typing. The system may identify patterns in user typing on social media and the like to better identify an appropriate response to the user. Finally, the system may provide a backend learning platform for the representative. This way the representative may interact with the virtual assistant via a multi-channel cognitive resource platform to provide feedback to the representative from interactions with the user. The virtual assistant also becomes the representatives coach throughout the experience. Guiding the quality of the interactions and giving real-time feedback to the representative on job performance and growth opportunities.

Embodiments of the invention are directed to a system, method, or computer program product for a learning system that integrates within multi-channel cognitive resource application, the invention comprising: generating user information into centralized database for storyboard integration; identifying a user event triggering strategy decision engine determination based on keyword recognition within user and multi-channel cognitive resource application communication; presenting strategy decision engine determination to a representative via the storyboard; triggering representative interjection between user and multi-channel cognitive resource application communication; mirroring the storyboard to user to illustrate strategy decision engine determination to the user; and providing a feedback loop via the storyboard for representation feedback.

In some embodiments, the invention further comprises integrating the multi-channel cognitive resource application into the strategy decision engine for user/representative communications, wherein the multi-channel cognitive resource application links the representative to the for communication.

In some embodiments, the multi-channel cognitive resource application further comprises: a language processing module to receive spoken statements from the user to trigger representative interjection of user communication with the multi-channel cognitive resource application; and a transmitter that transmits audible signals to the user in response to the received spoken statement from the user.

In some embodiments, triggering representative interjection between user and multi-channel cognitive resource application communication further comprises identifying a trigger phrase that displays user information to the representative, wherein the user information is a written illustration of a user interaction with the multi-channel cognitive resource application with overlayed highlighted key interaction statements of the user.

In some embodiments, triggering representative interjection between user and multi-channel cognitive resource application communication further comprises allowing user and multi-channel cognitive resource application communication interruption by the representative via a second interaction channel.

In some embodiments, the strategy decision engine comprises an artificial intelligence module for identification of accounts in pre-arrears status and products for arrears prevention.

In some embodiments, the feedback loop via the storyboard for representation feedback further comprises storing comments made by the representative during communication with the user and provides training modules to the representative based on communication style and the comments made by the representative.

In some embodiments, the invention further comprises presenting a graphical user interface mirroring for user visualization via a user device of a screen of a representative device.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a recovery workstation system environment, in accordance with one embodiment of the present invention;

FIG. 2 illustrates a high level process flow of generating user information within the recovery workstation platform, in accordance with one embodiment of the invention;

FIG. 3 illustrates a high level process flow of performing an omni channel user interaction and deployment of strategy decisioning, in accordance with one embodiment of the invention;

FIG. 4 depicts a high level process flow of the multi-channel cognitive resource application, in accordance with one embodiment of the invention;

FIG. 5 illustrates a high level process flow of representative interface and interaction during user interaction, in accordance with one embodiment of the invention;

FIG. 6 illustrates a high level process flow of user product presentation, in accordance with one embodiment of the invention;

FIG. 7 illustrates a graphical representation of a representative storyboard, in accordance with one embodiment of the invention;

FIG. 8 illustrates a graphical representation of focused representative storyboard, in accordance with one embodiment of the invention;

FIG. 9 illustrates a graphical representation of focused representative storyboard, in accordance with one embodiment of the invention; and

FIG. 10 illustrates a graphical representation of a representative feedback storyboard, in accordance with one embodiment of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to a system, method, or computer program product for a pre-collections recovery learning system that integrates a virtual assistant on both front and back end (for both the user and the representative). The system comprises a hub or workstation for representatives while also allowing for virtual assistant integration as a communication liaison with the user for collections and recovery. The system may initiate a communication with a user via chat, text, telephone, or the like. The user may interact initially with the virtual assistant. The system may identify key words during the interaction and provide those points to a representative via a storyboard. As such, the system may present the representative with the user platform and the key points based on the initial communication with the virtual assistant. From there, the representative may seamlessly transfer communication from the virtual assistant to the representative. The system provides several other features via the workstation that may be presented on an representative's screen, such as recommended products for the user based on the user's situation and a mirror option that allows the representative to display his/her screen to the user to illustrate how the products may work. The user may be able to sign up and initiate that product at that time via the mirroring option. This also includes the representative being able to view the user filling out applications for the products and allow the representative to help walk the user through the product. Additional add on elements includes a determination of typing shortcuts to identify the user's current disposition based on typing. The system may identify patterns in user typing on social media and the like to better identify an appropriate response to the user. Finally, the system may provide a backend learning platform for the representative. This way the representative may interact with the virtual assistant via a multi-channel cognitive resource platform to provide feedback to the representative from interactions with the user. The virtual assistant also becomes the representatives coach throughout the experience. Guiding the quality of the interactions and giving real-time feedback to the representative on job performance and growth opportunities.

As used herein, an “account” is the relationship that a user has with an entity and resources stored therein. The account is associated with and/or maintained by the entity. In some embodiments, as used herein the term “activity” may refer to any game, data presentation, product purchase, service purchase, product discount, movement to a location, or the like. In some embodiments, a “user event” may be an event happening in the life of a user that requires short term and long term preparation and planning. This includes relocating, career changes, having children, or the like.

As used herein, a “user” may be an entity user or an individual that integrated or otherwise utilized the applications disclosed herein. A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software. In some embodiments, the term “platform” including the temporal platform may refer to a platform that is used as a base upon which other applications, processing, or technologies are distributed including applications, activities, integration into currently used applications, integration into systems, presentation of user interfaces, and the like.

Further, the embodiments described herein may refer to use of a transaction or transaction event. Unless specifically limited by the context, a “transaction” refers to any communication between the user and an entity. In some embodiments, for example, a transaction may refer to a purchase of goods or services, a return of goods or services, a payment transaction, a credit transaction, or other interaction involving a user's bank account. As further examples, a transaction may occur when an entity associated with the user is alerted. A transaction may occur when a user accesses a building, uses a rewards card, and/or performs an account balance query. A transaction may occur as a user's device establishes a wireless connection, such as a Wi-Fi connection, with a point-of-sale terminal. In some embodiments, a transaction may include one or more of the following: purchasing, renting, selling, and/or leasing goods and/or services; withdrawing cash; making payments to creditors; sending remittances; transferring balances from one account to another account; loading money onto stored value cards (SVCs) and/or prepaid cards; donating to charities; and/or the like.

Furthermore, the term “product” or “account” as used herein may include any financial product, service, or the like that may be provided to a user from an entity that subsequently requires payment. A product may include an account, credit, loans, purchases, agreements, or the like between an entity and a user. The term “relationship” as used herein may refer to any products, communications, correspondences, information, or the like associated with a user that may be obtained by an entity while working with a user. User relationship data may include, but is not limited to addresses associated with a user, user contact information, user associate information, user products, user products in arrears, or other information associated with the user's one or more accounts, loans, products, purchases, agreements, or contracts that a user may have with the entity.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that utilized accounts in arrears recovery or pre-recovery.

Embodiments of the invention are directed to a system, method, or computer program product for providing a pre-arrears learning system with multi-channel cognitive resource application integration on front and back end applications. The system comprises a hub or workstation for representatives while also allowing for multi-channel cognitive resource application integration as a communication liaison with the user product identification. The system may identify key words during the interaction and provide those points to an representative via a storyboard. Furthermore, the system provides a strategy decision engine for product matching for the user, which allows the representative to mirror graphical user interfaces with the user device for product application.

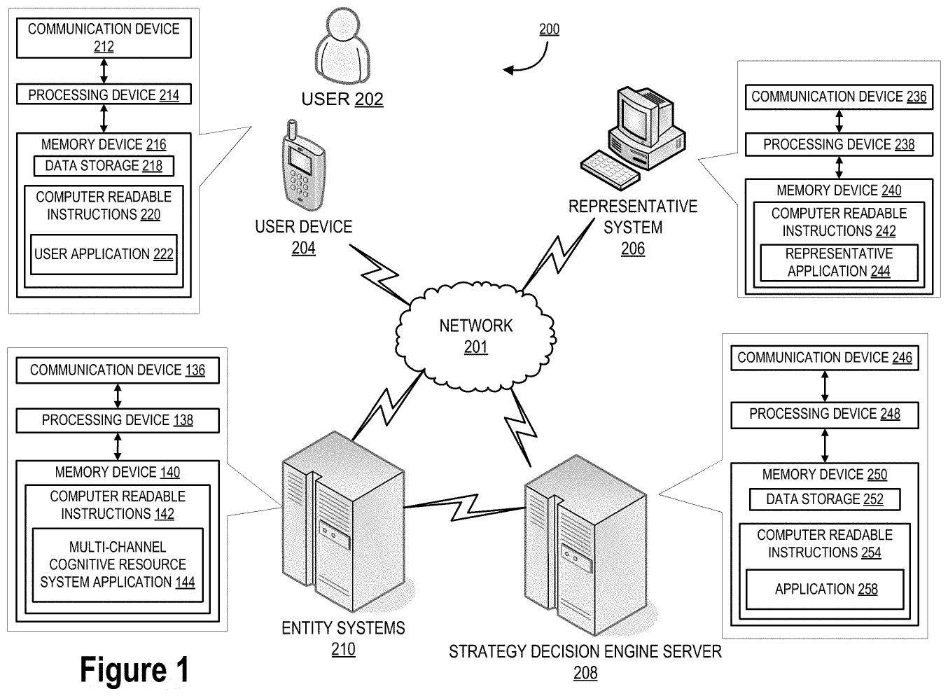

FIG. 1 provides a recovery workstation system environment 200, in accordance with one embodiment of the present invention. As illustrated in FIG. 1, the strategy decision engine server 208 is operatively coupled, via a network 201 to the user device 204, to the representative system 206, and to entity systems 210. In this way, the strategy decision engine server 208 can send information to and receive information from the user device 204, the representative system 206, and the entity systems 210. FIG. 1 illustrates only one example of the system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

As illustrated in FIG. 1, the strategy decision engine server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the representative system 206, the user device 204, and the entity systems 210. As such, the communication device 246 generally comprises a modem, server, or other device for communicating with other devices on the network 201.

As further illustrated in FIG. 1, the strategy decision engine server 208 comprises computer-readable instructions 254 stored in the memory device 250, which in one embodiment includes the computer-readable instructions 254 of an application 258. In some embodiments, the memory device 250 includes data storage 252 for storing data created and/or used by the application 258. In the embodiment illustrated in FIG. 1 and described throughout much of this specification, the application 258 may perform the functions disclosed herein. I

As illustrated in FIG. 1, the representative system 206 generally comprises a communication device 236, a processing device 238, and a memory device 240.

As further illustrated in FIG. 1, the representative system 206 comprises computer-readable instructions 242 stored in the memory device 240, which in one embodiment includes the computer-readable instructions 242 of a representative application 244.

In some embodiments, a representative system 206 is or includes an interactive computer terminal that is configured to initiate, perform, complete, and/or facilitate one or more communication events with a user 202.

In the embodiment illustrated in FIG. 1, the representative application 244 allows the representative system 206 to be linked to the strategy decision engine server 208 to communicate, via a network 201, the information related to transactions and accounts associated with a user to a user.

FIG. 1 also illustrates a user device 204. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the representative system 206, the strategy decision engine server 208, and the entity systems 210. As such, the communication device 212 generally comprises a modem, server, or other device for communicating with other devices on the network 201.

As further illustrated in FIG. 1, the user device 204 comprises computer-readable instructions 220 stored in the memory device 216, which in one embodiment includes the computer-readable instructions 220 of a user application 222. In this way, a user 202 may be able to opt-in to the program, interact with the application, and/or the like using the user application 222. A “mobile device” 204 may be any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. Although only a single user device 204 is depicted in FIG. 1, the payment account determination system environment 200 may contain numerous mobile devices 204.

The entity systems 210 are operatively coupled to the strategy decision engine server 208, the representative system 206, and/or the user device 204 through the network 201. The entity systems 210 have systems with devices the same or similar to the devices described for the strategy decision engine server 208, the representative system 206, and/or the user device 204 (i.e., communication device, processing device, and memory device). Therefore, the entity systems 210 communicate with the strategy decision engine server 208, the representative system 206, and/or the user device 204 in the same or similar way as previously described with respect to each system.

As such, the entity systems 210 generally comprises a communication device 136, at least one processing device 138, and a memory device 140. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 138 is operatively coupled to the communication device 136 and the memory device 140. The processing device 138 uses the communication device 136 to communicate with the network 201 and other devices on the network 201. As such, the communication device 136 generally comprises a modem, server, wireless transmitters or other devices for communicating with devices on the network 2001. The memory device 140 typically comprises a non-transitory computer readable storage medium, comprising computer readable/executable instructions/code, such as the computer-readable instructions 142, as described below.

As further illustrated in FIG. 1, the entity system 206 comprises computer-readable instructions 142 or computer readable program code 142 stored in the memory device 140, which in one embodiment includes the computer-readable instructions 142 of a multi-channel cognitive resource system application 144 (also referred to as a “system application” 144). The computer readable instructions 142, when executed by the processing device 138 are configured to cause the system 106/processing device 138 to perform one or more steps described in this disclosure to cause out systems/devices (such as the user device 204, the user application 222, and the like) to perform one or more steps described herein. In some embodiments, the memory device 140 includes a data storage for storing data related to user transactions and resource entity information, but not limited to data created and/or used by the multi-channel cognitive resource system application 144.

It is understood that the servers, systems, and devices described herein illustrate one embodiment of the invention. It is further understood that one or more of the servers, systems, and devices can be combined in other embodiments and still function in the same or similar way as the embodiments described herein.

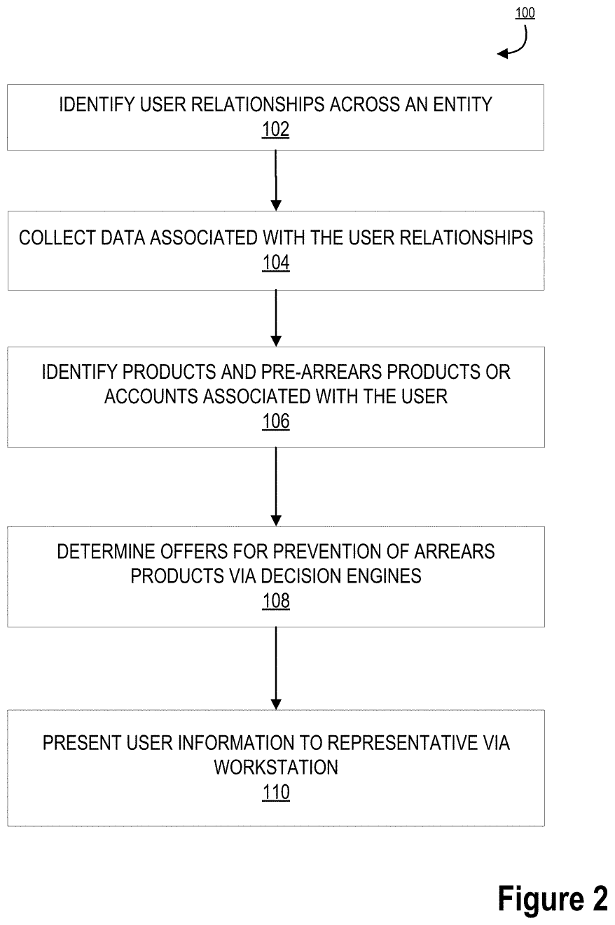

FIG. 2 illustrates a high level process flow of generating user information within the recovery workstation platform 100, in accordance with one embodiment of the invention. As illustrated in block 102, the process 100 is initiated by identifying the user accounts and other relationships across the financial institution. In this way, the system may identify all products that a user may have with the entity across one or more lines of business within the entity. As such, addresses, associations, phone numbers, user products, products with potential of being in arrears, and any other information that may be associated with a single user may be gathered across the lines of business of an entity. Next, as illustrated in block 104, the data associated with the user relationships may be collected and compiled in association with the user within a centralized platform. As such, all relationship data may be stored in association with a user including those products and/or accounts.

The next step in the process 100, as illustrated in block 106, is to identify products and pre-arrears products or accounts associated with the user. As such, the products or accounts that the user may have with the financial institution may be identified. These may include accounts, loans, or the like.

The system may identify either an account in pre-arrears or a life event associated with the user that may change his/her financial position that may potentially place an account or product owned by the user into arrears.

Next, as illustrated in block 108, the process 100 continues by determining one or more offers for aiding the user and prevention of possible accounts in arrears. The system may do this via a strategy decision engine comprising machine learning and artificial intelligence processing of the user's current products at the financial institution, triggering event that lead to possible pre-arrears account scenario, products the user may qualify for within the financial institution, and the like. In this way, the system may identify one or more products that the financial institution may offer the user to potentially prevent the user from having one or more accounts in an arrears situation.

Finally, as illustrated in block 110, the process 100 is finalized by presenting user information to a representative via a representative workstation. The representative may gain access to and easily visualize an across entity view of the user's relationship with the entity as well as information associated with the primary account and other accounts of the user, with an indication of the triggering event that caused the pre-arrears position. Furthermore, the workstation provides information associated with prior user communications, such as outcomes of previous discussions, including but not limited to payment agreements, product discussions, communication times, call back dates, or the like.

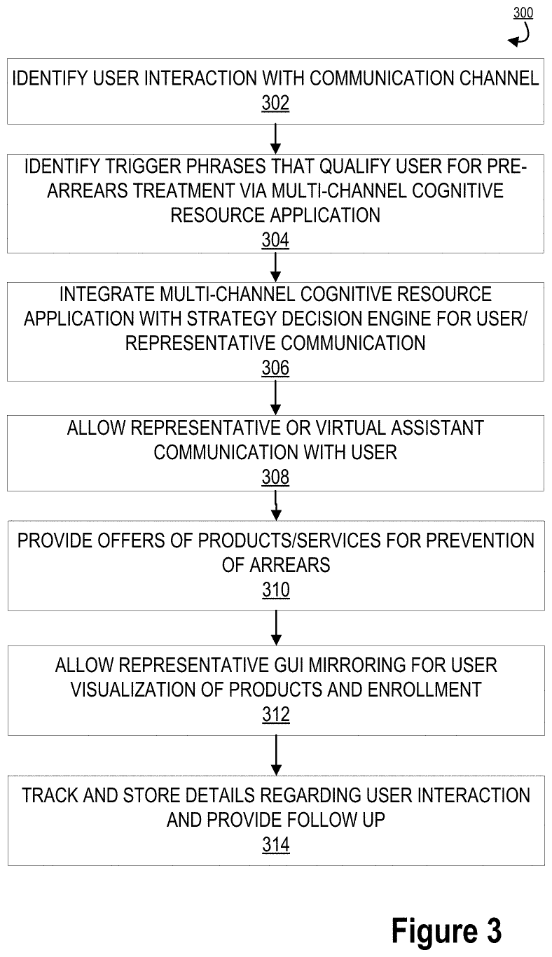

FIG. 3 illustrates a high level process flow of performing an omni channel user interaction and deployment of strategy decisioning 300, in accordance with one embodiment of the invention. As illustrated in block 302, the process 300 is initiated by identifying a new user interaction with a communication channel. In this way, the user may be communicating via chat, messenger, telephone, or the like. In some embodiments the user may be interacting with a virtual assistant such as the multi-channel cognitive resource application. The multi-channel cognitive resource application may identify trigger phrases or works that activate the system response. In this way, the multi-channel cognitive resource application may identify trigger phrases that qualify the user for pre-arrears treatment via the multi-channel cognitive resource application, as illustrated in block 304. These triggers may be trigger words spoken or text from the user to the multi-channel cognitive resource application that indicate a change in financial situation that may lead to a product or account the user has with the financial institution to be in arrears at a time in the future.

Next, as illustrated in block 306, the process 300 continues by integrating the multi-channel cognitive resource application with the strategy decision engine for user/representative communications. In this way, the system links a representative, via a workstation, to the user for communication. The system may provide user information on the representative's workstation and provide the user communication with the virtual assistant. In this way, all user information may be centralized, such that the representative can log into a single system. This eliminates requiring the representative to log into a plurality of software programs in order to view and understand all relationships a user has with the entity.

The user and virtual assistant may still be communicating, which allows the representative to review the user information and review the user communication with the multi-channel cognitive resource application prior to interrupting or stepping in. However, the system integrates the multi-channel cognitive resource application communication with the representative workstation to allow the representative to provide user input at any time.

As illustrated in block 308, the process 300 continues by allowing the representative or virtual assistant to communicate with the user. The representative may have access to the user's previous communications with the virtual assistant or prior communications with one or more other representatives. Furthermore, the representative may have access to the one or more offers determined by the strategy decision engine. As such, the representative may receive product offer options from the strategy decision engine. The strategy decision engine may determine one or more offers for aiding the user and prevention of possible accounts in arrears. The system may do this via a strategy decision engine comprising machine learning and artificial intelligence processing of the user's current products at the financial institution, triggering event that lead to possible pre-arrears account scenario, products the user may qualify for within the financial institution, and the like. In this way, the system may identify one or more products that the financial institution may offer the user to potentially prevent the user from having one or more accounts in an arrears situation.

The system may be able to illustrate what the user's financial situation may look like at a future time if the user enrolled in one or more of the offer products provided. The representative may allow for his/her graphical user interface (GUI) to be shared with the user device. In this way, as illustrated in block 312, the process 300 continues by allowing for representative GUI mirroring for visualization of products of the offers, illustrating the outcome of using those products, and allowing for user enrollment of those products.

Finally, the system may track and store details regarding the user interaction with the representative and provide follow up, as illustrated in block 314. This may include follow up with the user or with the representative. In some embodiments, the system may automatically determine, track, and store information associated with the user communication. In other embodiments, the system may require the representative to input a communication disposition prior to termination of the process. In this way, the system may track the disposition of the communication, such as determining if a communication was answered by the user, a busy signal was received, or that the user answered the communication. The system may identify the date, time, means of communication (such as specific telephone number, email address, or the like). Furthermore, the system may store any comments or notes made by the representative during the communications. Furthermore, the representative may receive feedback about his/her performance, communication style, or the like for learning and training purposes. The system may also que the same representative for each time that user contacts the entity, such that there is familiarity for the user.

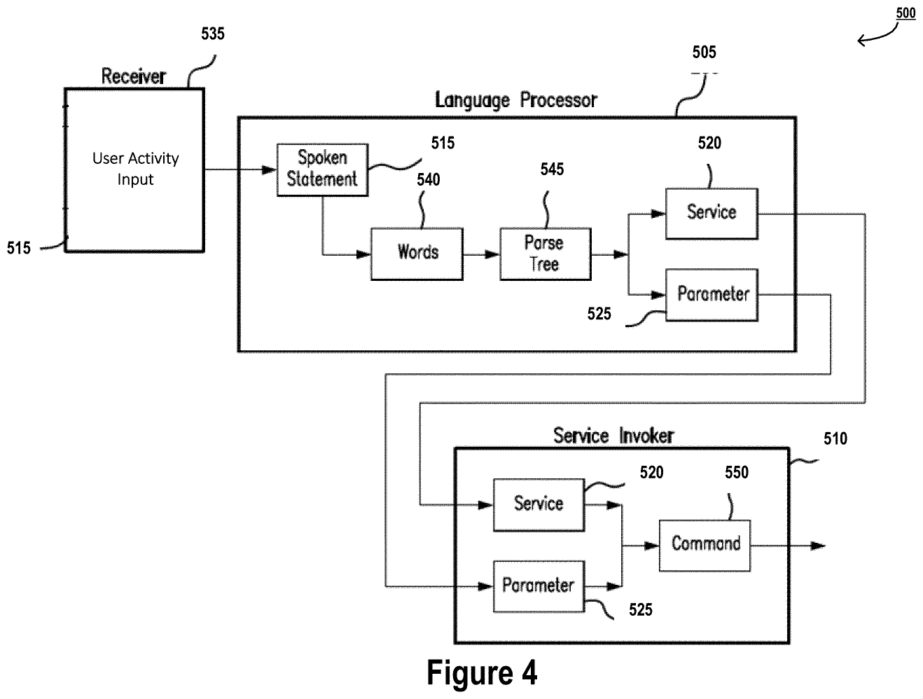

FIG. 4 illustrates a high level process flow of the multi-channel cognitive resource application, in accordance with some embodiments of the invention. The language processing module 500 is typically a part of the multi-channel cognitive resource application of the user device, although in some instances the language processing module resides on the system. The natural language of the user comprises linguistic phenomena such as verbs, phrases and clauses that are associated with the natural language of the user. The system is configured to receive, recognize and interpret these linguistic phenomena of the user input and perform user activities accordingly. In this regard, the language processing module is configured for natural language processing and computational linguistics. As illustrated in FIG. 4, the system includes a receiver 535 (such as a microphone, a touch screen or another user input or output device), a language processor 505 and a service invoker 510.

Receiver 535 receives an activity input 515 from the user, such as a spoken statement 515 provided using an audio communication medium. Although described with respect to an audio communication medium, the language processing module 500 is not limited to this medium and is configured to operate on input received through other mediums such as textual input, graphical input (such as sentences/phrases in images or videos), and the like. As an example, the user may provide an activity input comprising the sentence “I want to pay my June internet bill”. The receiver 535 may receive the spoken statement 515 and forward the spoken statement 515 to the language processor 505. An example algorithm for the receiver 535 is as follows: wait for activity input; receive activity input; pick up activity input; receive spoken statement 515; and forward spoken statement 515 to language processor 505.

The language processor 505 receives spoken statement 515 and processes spoken statement 515 to determine an appropriate activity 520 or activity event 520 to invoke to respond to activity input and any parameters 525 needed to invoke activity 520. The language processor 505 may detect a plurality of words 540 in spoken statement 515. Using the previous example, words 540 may include: pay, June, internet, and bill. The language processor 505 may process the detected words 540 to determine the activity 520 to invoke to respond to activity input.

The language processor 505 may generate a parse tree based on the detected words 540. Parse tree may indicate the language structure of spoken statement 515. Using the previous example, parse tree may indicate a verb and infinitive combination of “want” and “to pay” and an object of “bill” with the modifiers of “June” and “internet.” The language processor 505 may then analyze the parse tree to determine the intent of the user and the activity associated with the conversation to be performed. For example, based on the example parse tree, the language processor 505 may determine that the user wants to pay a bill.

The language processor 505 may also determine from the parse tree that “bill” is modified by “June” and “internet.” The language processor 505 may extract “June” and “internet” as values for parameters 525 (e.g. date and type parameters) to the bill pay activity 520. The values of the parameters 525 may be “June” and “internet.” The language processor 505 may then forward the determined activity 520 and the values of the parameters 525 to service invoker 510.

An example algorithm for the language processor 505 is as follows: wait for spoken statement 515; receive spoken statement 515 from receiver 535; parse spoken statement 515 to detect one or more words 540; generate parse tree using the words 540; detect an intent of the user by analyzing parse tree; use the detected intent to determine a service to invoke; extract values for parameters from parse tree; and forward activity 520 and the values of parameters 525 to service invoker 510.

Next, the service invoker 510 receives determined activity 520 comprising required functionality and the parameters 525 from the language processor 505. The service invoker 510 may analyze activity 520 and the values of parameters 525 to generate a command 550. Command 550 may then be sent to instruct that activity 520 be invoked using the values of parameters 525. In response, the language processor 505 may invoke a bill pay functionality of an internet provider resource application of the user device, for example, by extracting pertinent elements and embedding them within the central user interface as discussed previously. An example algorithm for service invoker 510 is as follows: wait for activity 520; receive activity 520 from the language processor 505; receive the values of parameters 525 from the language processor 505; generate a command 550 to invoke the received activity 520 using the values of parameters 525; and communicate command 550 to invoke activity 520.

In some embodiments, the system also includes a transmitter that transmits audible signals, such as questions, requests and confirmations, back to the user. For example, if the language processor 505 determines that there is not enough information in spoken statement 515 to determine which activity 520 should be invoked, then the transmitter may communicate an audible question back to the user for the user to answer. The answer may be communicated as another spoken statement 515 that the language processor 505 can process to determine which activity 520 should be invoked. As another example, the transmitter may communicate a textual request back to the user. If the language processor 505 determines that certain parameters 525 are needed to invoke a determined activity 520 but that the user has not provided the values of these parameters 525. For example, if the user had initially stated “I want to pay my bill,” the language processor 505 may determine that certain values for parameter 525 are missing. In response, the transmitter may communicate the audible request “do you want to pay your telephone, internet or television bill?” As yet another example, the transmitter may communicate an audible confirmation that the determined activity 520 has been invoked. Using the previous example, the transmitter may communicate an audible confirmation stating “Great, let me forward you to the internet bill pay service.” In this manner, the system may dynamically interact with the user to determine the appropriate activity 520 to invoke to respond to the user.

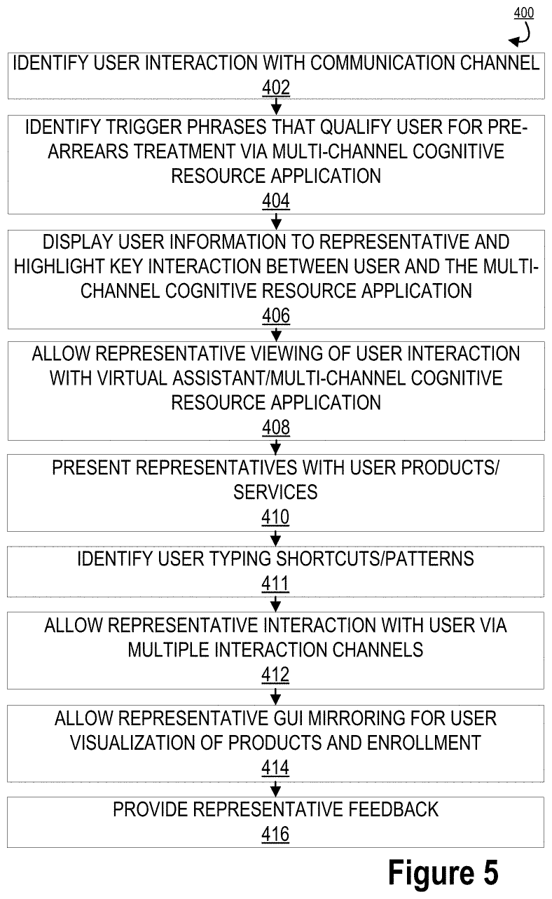

FIG. 5 illustrates a high level process flow of representative interface and interaction during user interaction 400, in accordance with one embodiment of the invention. As illustrated in block 402, the process 400 is initiated by identifying user interaction with a communication channel. In this way, the user may be communicating with the multi-channel cognitive resource application via text communications, voice communications, or the like. Next, as illustrated in block 404, the process 400 continues by identifying a trigger phrase that qualifies the user for pre-arrears treatment and initiates the strategy decision engine application. In this way, the system provides pre-collection recover, giving user product offers for prevention of accounts in arrears situations.

As illustrated in block 406, the process 400 continues by displaying user information to a representative. Along with the user information, the system may display the user communication with the multi-channel cognitive resource application. The system may highlight key interactions between the user and the multi-channel cognitive resource application. The highlighted interactions may be easily visible by the representative and provide an indication as to the event that triggered the user correspondence. The event may be any action or activity that may impact a product the user has at the financial institution that may lead to the product being in arrears at a point in the near future.

As illustrated in block 408, the process 400 continues by allowing the representative to view the user interaction with the virtual assistant or multi-channel cognitive resource application. This way the representative can view what the user has been discussing and be updated on the events associated with the user. The representative may also visualize the user information on the same workstation. This information may include information about the user, accounts associated with the user, products the user has, and the like.

Next, the strategy decision engine may determine one or more products or services to provide to the user that may eliminate an in arrears situation in one or more of the user's current accounts, as illustrated in block 410. These may be identified based on machine learning artificial intelligence with future projection of the user's wholistic financial view after implementation of the one or more products or services. The products or services may be products offered by the financial institution that may save the user resources, distribute payments, aggregate payments, or in other means alleviate strain from the triggered event and prevent an arrears situation.

As illustrated in block 411, the process 400 continues by identifying user typing shortcuts and patterns when typing with the virtual assistant. In this way, the system may identify standard text patterns and shortcuts of the user via social media posting, texting, and previous interactions with the multi-channel cognitive resource application. Using this information the system may be able to identify if the user is typing the same or differently than historically identified. This may provide an indication of the condition the user is in with respect to frustration, stress, or the like based on the triggering event or the current communication. This information may be provided to the representative on the workstation.

Next, as illustrated in block 412, the process 400 continues by allowing the representative to interact with the user via multiple interaction channels. As such, the representative may be able to take the place of the virtual assistant and interject into the communication in order to present offers to the user for the one or more products identified to aid the user determined by the strategy decision engine. The representative may be able to switch back and forth between various communication channels. Furthermore, the representative may also be able to implement virtual assistant interaction with either the user or the representative. The multi-channel cognitive resource application may continue to monitor the representative communication for subsequent analysis and feedback to the representative.

As illustrated in block 414, the process 400 continues by allowing the representative to mirror the graphical user interface (GUI) of the representative's screen to the user device. This way the user may be able to visualize the changes that may occur within the user's financial situation upon implementation of the one or more products. The representative can share the GUI and provide a visual to the user for implementation of the products. Furthermore, upon selection of a product, the mirroring may allow the representative to walk the user through the step by step processing of applying for or enrolling in the product selected.

Finally, as illustrated in block 416, the process 400 is completed by providing representative feedback based on the multi-channel cognitive resource application review of the representative actions, comments, or the like when the user was interacting with the user.

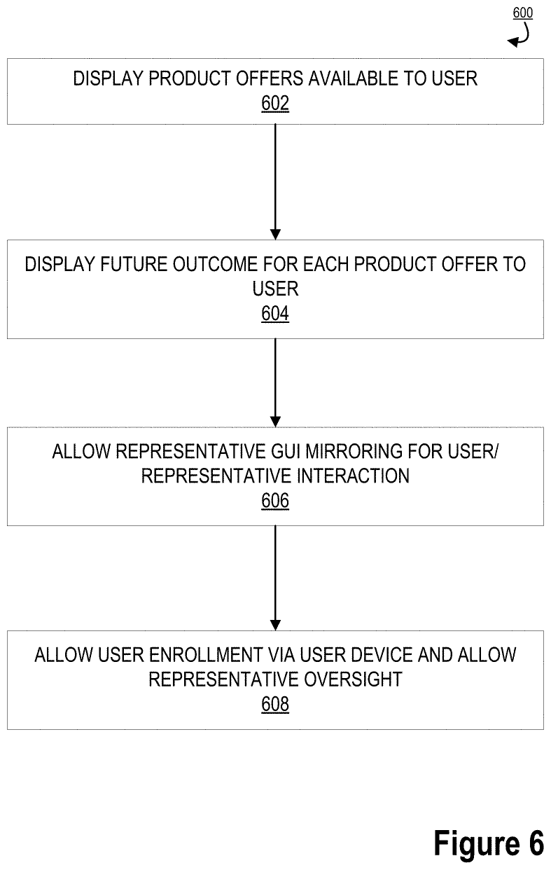

FIG. 6 illustrates a high level process flow of user product presentation 600, in accordance with one embodiment of the invention. As illustrated in block 602, the process 600 is initiated by displaying product offers available to the user. These may be products that the user qualifies for and that may aid in prevention of an account in arrears situation, such as interest, loans, modifications to current accounts, or the like.

As illustrated in block 604, the process 600 continues by displaying future outcomes for each of the product offers to the user. In this way, the system may visualize the user's current financial situation and adjust it in the future for illustration of the utilization of and enrollment into the particular product. This will give the user a visual representation of the product in use in the user's situation.

As illustrated in block 606, the process 600 continues by allowing the representative GUI to be mirrored onto the user device for user/representative interactions. As such, the system may be able to allow the user to visualize what is on the representative's screen allowing the representative to point, click, select, and the like various options as feedback for the user. Finally, as illustrated in block 608, the process 600 is completed by allowing the user to enroll in a product selected via a user device with representative oversight. In this way, the system may also allow representative visualization of the GUI associated with the user device.

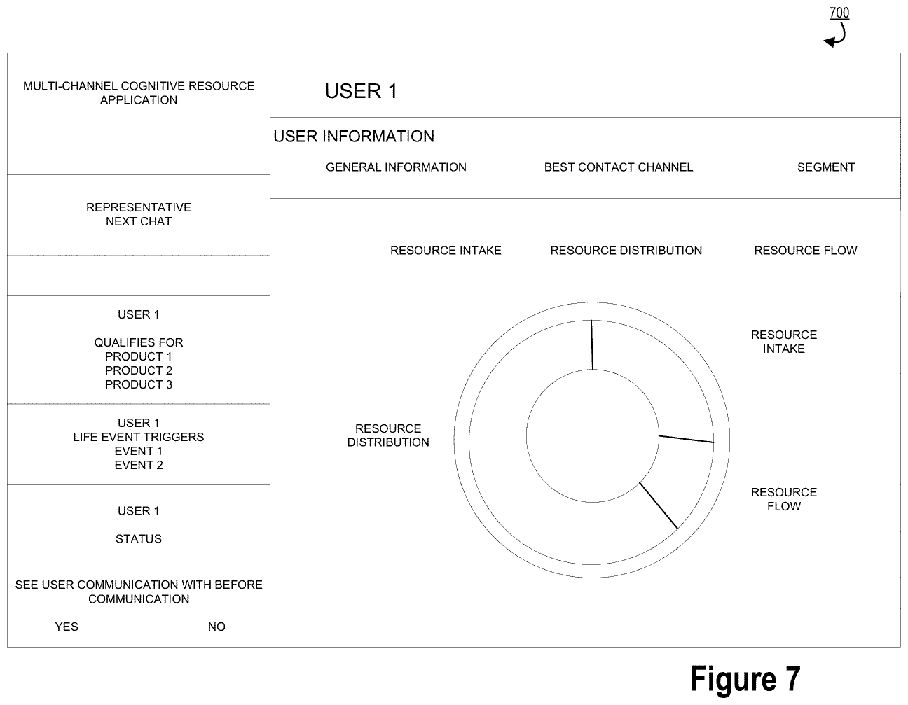

FIG. 7 illustrates a graphical representation of a representative storyboard 700, in accordance with one embodiment of the invention. This is a GUI storyboard that is displayed to a representative that is in preparation to communicate with the user. As illustrated on the left of the GUI storyboard, the multi-channel cognitive resource application pane is displayed. The representative is provided with the next user, User 1. The representative is also provided with the products that the strategy decision engine may have identified for User 1. Furthermore, the multi-channel cognitive resource application pane of the storyboard may indicate the life events that triggered User 1 initial correspondence, these may be identified as keywords that the user has used when communicating with the multi-channel cognitive resource application prior to representative interjection. These may be words like “moving”, “changing job”, or other life events that may trigger a pre-arrears situation.

Next, as illustrated in the multi-channel cognitive resource application pane, the representative is provided with User 1 financial status, such as the products User 1 has, the last transactions associated with those products, and the like. Finally, in the multi-channel cognitive resource application pane, the representative may select the option of seeing User 1 communications with the multi-channel cognitive resource application prior to the representative involvement.

FIG. 7 also includes a user pane for User 1. This includes information about User 1, such as general information, best contact channel, contact information, and the user segment, such as a warning level of arrears. Furthermore, the user information may include User 1 current disposition based on typing shortcuts/patterns.

The main body of the user pane comprises information about User 1 resources including an exploding, selectable pie graph illustrating User 1 resource intake, resource distributions, and resource flow. In some embodiments, resource distributions include a time frame illustration of the resource distributions of User 1, such as where User 1 spends resources, reoccurring resource spending, and the like. In some embodiments, resource intake may include any resources received regularly by User 1, such as a salary or the like. In some embodiments, resource flow illustrates a year term or longer term of flow of resources for User 1.

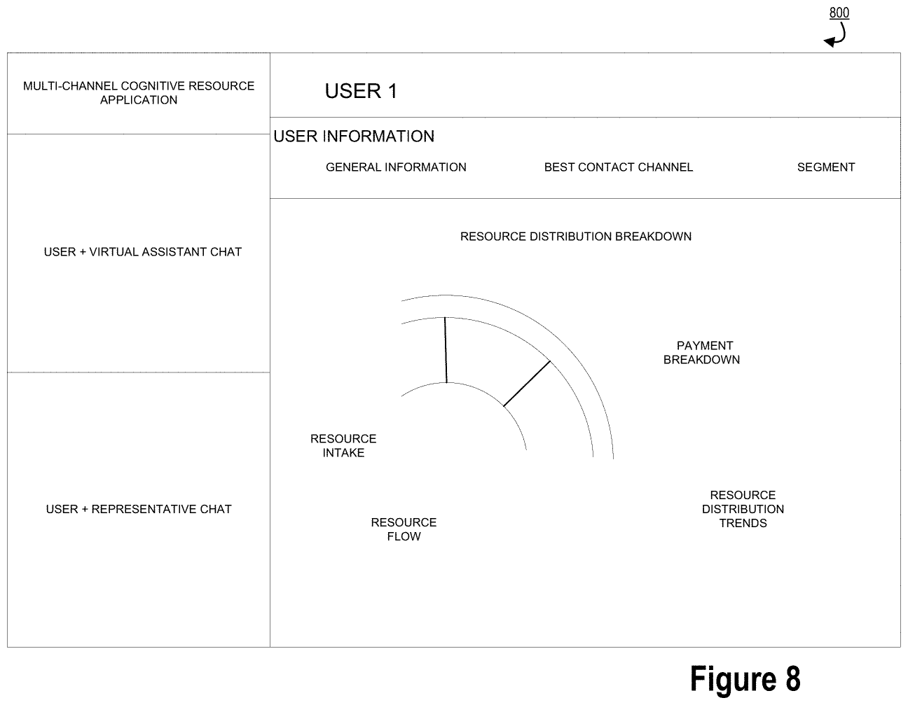

FIG. 8 illustrates a graphical representation of focused representative storyboard 800, in accordance with one embodiment of the invention. The storyboard GUI comprises a multi-channel cognitive resource application pane and a user pane. The multi-channel cognitive resource application pane on the left column of the storyboard includes user+virtual assistant chat history. This pane may also comprise current chat. The multi-channel cognitive resource application pane also includes the user+representative chat history and a current chat pane.

FIG. 8 also includes a user pane for User 1. This includes information about User 1, such as general information, best contact channel, contact information, and the user segment, such as a warning level of arrears. Furthermore, the user information may include User 1 current disposition based on typing shortcuts/patterns.

The main body of the user pane comprises information about User 1 resources including an exploded version of the selectable pie graph illustrating User 1 resource distributions. In some embodiments, resource distributions include a time frame illustration of the resource distributions of User 1, such as where User 1 spends resources, reoccurring resource spending, and the like. The user pane further includes the payment breakdown of the resource distributions of the user, trends in resource distribution behavior, and the like.

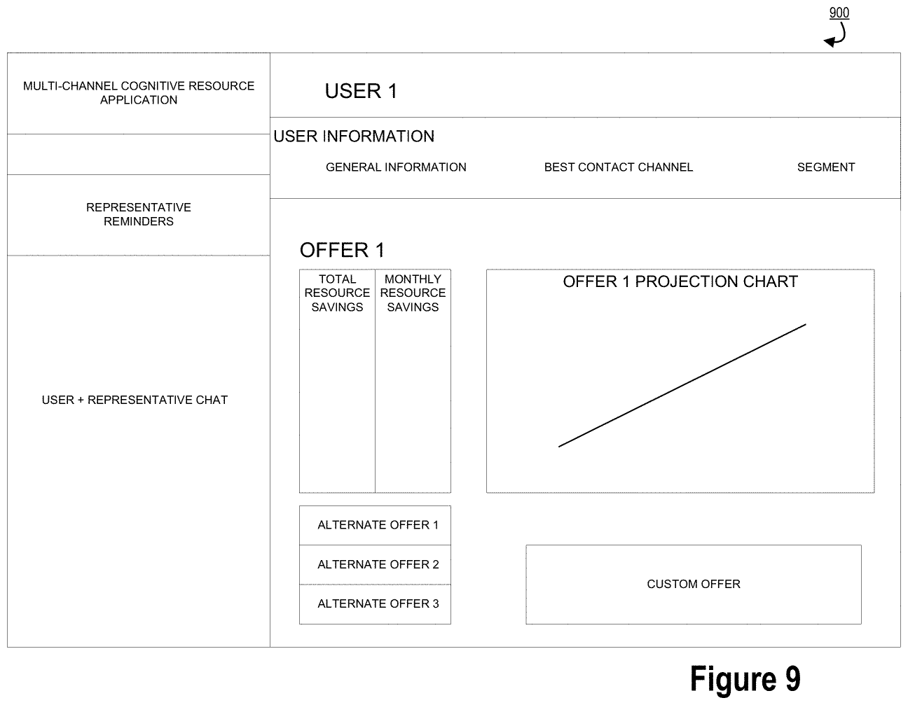

FIG. 9 illustrates a graphical representation of focused representative storyboard 900, in accordance with one embodiment of the invention. The storyboard GUI comprises a multi-channel cognitive resource application pane and a user pane. The multi-channel cognitive resource application pane on the left column of the storyboard includes system reminders for the representative. These may be key talking points, product offers, items to mention based on product selection, or the like. The representative may utilize this pane to ensure that all talking points with the user are hit for this particular session. Next, the multi-channel cognitive resource application pane includes the current and recent historic user+representative chat communications.

FIG. 9 also includes a user pane for User 1. This includes information about User 1, such as general information, best contact channel, contact information, and the user segment, such as a warning level of arrears. Furthermore, the user information may include User 1 current disposition based on typing shortcuts/patterns. This user pane may also include information about Offer 1. The representative may mirror a portion of the representative's GUI to the user device for user visualization. This mirroring may be mirroring of just this portion of the representative's GUI. The Offer 1 may illustrate a total resource savings and a monthly resource savings for Offer 1. Furthermore, the user pane may show the Offer 1 projection chart for User 1 illustrating how User 1 financial outlook will look as the product of Offer 1 is being implemented in the future.

The system may also provide alternate offers to provide User 1, in this example, they include Alternate Offer 1, Alternate Offer 2, and Alternate Offer 3. Finally, the system may provide the representative with custom offers for User 1 and the representative to review.

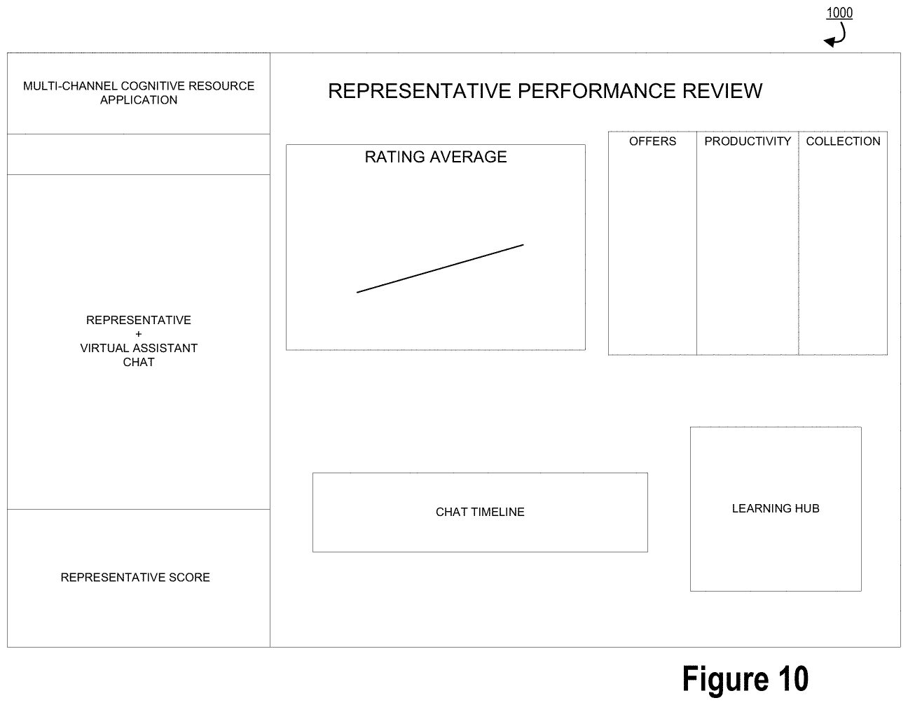

FIG. 10 illustrates a graphical representation of a representative feedback storyboard 1000, in accordance with one embodiment of the invention. This storyboard is provided to the representative after the communication with the user. The storyboard GUI comprises a multi-channel cognitive resource application pane and a representative pane. The multi-channel cognitive resource application pane on the left column of the storyboard includes current and historic representative+virtual assistant communication discussing the representative feedback with respect to the representative communication with the user. Below the chat, the system may provide the representative with an overall performance score, as a representative score. This will provide the representative with information about how well the representative performed and made sure the representative provided all off the information to the user for the different offers and based on the particular user.

The representative pane includes a representative performance review of the representative communication with the user. First, the representative pane includes a rating average of performance of the representative on historic communications between the representative and users over the course of time. This includes multi-channel cognitive resource application score, a user rating, a representative personal rating, and a manager rating. The representative pane includes a chat timeline with various points along the chat timeline with the user were the representative excelled or provided good input to the user. The representative pane includes statistical averages for offers, productivity, and collections for the representative. Finally, the representative pane includes a learning hub for representative learning and training.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for a learning system that integrates within multi-channel cognitive resource application, the system comprising:
a memory device with computer-readable program code stored thereon;
a communication device;
a processing device operatively coupled to the memory device and the communication device, wherein the processing device is configured to execute the computer-readable program code to:
generate user information into centralized database for storyboard integration;
identify a user event triggering strategy decision engine determination based on keyword recognition within user and multi-channel cognitive resource application communication;
present strategy decision engine determination to a representative via the storyboard;
trigger representative interjection between user and multi-channel cognitive resource application communication;
mirror the storyboard to user to illustrate strategy decision engine determination to the user; and
provide a feedback loop via the storyboard for representation feedback.

2. The system of claim 1, further comprising integrating the multi-channel cognitive resource application into the strategy decision engine for user/representative communications, wherein the multi-channel cognitive resource application links the representative to the for communication.

3. The system of claim 2, wherein the multi-channel cognitive resource application further comprises:
a language processing module to receive spoken statements from the user to trigger representative interjection of user communication with the multi-channel cognitive resource application; and
a transmitter that transmits audible signals to the user in response to the received spoken statement from the user.

4. The system of claim 1, wherein triggering representative interjection between user and multi-channel cognitive resource application communication further comprises identifying a trigger phrase that displays user information to the representative, wherein the user information is a written illustration of a user interaction with the multi-channel cognitive resource application with overlayed highlighted key interaction statements of the user.

5. The system of claim 1, wherein triggering representative interjection between user and multi-channel cognitive resource application communication further comprises allowing user and multi-channel cognitive resource application communication interruption by the representative via a second interaction channel.

6. The system of claim 1, wherein the strategy decision engine comprises an artificial intelligence module for identification of accounts in pre-arrears status and products for arrears prevention.

7. The system of claim 1, wherein the feedback loop via the storyboard for representation feedback further comprises storing comments made by the representative during communication with the user and provides training modules to the representative based on communication style and the comments made by the representative.

8. The system of claim 1, further comprising presenting a graphical user interface mirroring for user visualization via a user device of a screen of a representative device.

9. A computer program product for a learning system that integrates within multi-channel cognitive resource application, the computer program product comprising at least one non-transitory computer-readable medium having computer-readable program code portions embodied therein, the computer-readable program code portions comprising:
an executable portion configured for generating user information into centralized database for storyboard integration;
an executable portion configured for identifying a user event triggering strategy decision engine determination based on keyword recognition within user and multi-channel cognitive resource application communication;
an executable portion configured for presenting strategy decision engine determination to a representative via the storyboard;
an executable portion configured for triggering representative interjection between user and multi-channel cognitive resource application communication;
an executable portion configured for mirroring the storyboard to user to illustrate strategy decision engine determination to the user; and
an executable portion configured for providing a feedback loop via the storyboard for representation feedback.

10. The computer program product of claim 9, further comprising an executable portion configured for integrating the multi-channel cognitive resource application into the strategy decision engine for user/representative communications, wherein the multi-channel cognitive resource application links the representative to the for communication.

11. The computer program product of claim 10, wherein the multi-channel cognitive resource application further comprises:
a language processing module to receive spoken statements from the user to trigger representative interjection of user communication with the multi-channel cognitive resource application; and
a transmitter that transmits audible signals to the user in response to the received spoken statement from the user.

12. The computer program product of claim 9, wherein triggering representative interjection between user and multi-channel cognitive resource application communication further comprises identifying a trigger phrase that displays user information to the representative, wherein the user information is a written illustration of a user interaction with the multi-channel cognitive resource application with overlayed highlighted key interaction statements of the user.

13. The computer program product of claim 9, wherein triggering representative interjection between user and multi-channel cognitive resource application communication further comprises allowing user and multi-channel cognitive resource application communication interruption by the representative via a second interaction channel.

14. The computer program product of claim 9, wherein the strategy decision engine comprises an artificial intelligence module for identification of accounts in pre-arrears status and products for arrears prevention.

15. The computer program product of claim 9, wherein the feedback loop via the storyboard for representation feedback further comprises storing comments made by the representative during communication with the user and provides training modules to the representative based on communication style and the comments made by the representative.

16. The computer program product of claim 9, further comprising an executable portion configured for presenting a graphical user interface mirroring for user visualization via a user device of a screen of a representative device.

17. A computer-implemented method for a learning system that integrates within multi-channel cognitive resource application, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
generating user information into centralized database for storyboard integration;
identifying a user event triggering strategy decision engine determination based on keyword recognition within user and multi-channel cognitive resource application communication;
presenting strategy decision engine determination to a representative via the storyboard;
triggering representative interjection between user and multi-channel cognitive resource application communication;
mirroring the storyboard to user to illustrate strategy decision engine determination to the user; and
providing a feedback loop via the storyboard for representation feedback.

18. The computer-implemented method of claim 17, further comprising integrating the multi-channel cognitive resource application into the strategy decision engine for user/representative communications, wherein the multi-channel cognitive resource application links the representative to the for communication.

19. The computer-implemented method of claim 17, wherein triggering representative interjection between user and multi-channel cognitive resource application communication further comprises identifying a trigger phrase that displays user information to the representative, wherein the user information is a written illustration of a user interaction with the multi-channel cognitive resource application with overlayed highlighted key interaction statements of the user.

20. The computer-implemented method of claim 17, wherein triggering representative interjection between user and multi-channel cognitive resource application communication further comprises allowing user and multi-channel cognitive resource application communication interruption by the representative via a second interaction channel.
